(19) United States
(12) Patent Application Publication
(10) Pub. No.: US 2020/0290477 A1
(43) Pub. Date: Sep. 17, 2020

(54) BATTERY LENDING SYSTEM, VEHICLE, SERVER, AND BATTERY LENDING METHOD

(71) Applicant: TOYOTA JIDOSHA KABUSHIKI KAISHA, Toyota-shi (JP)

(72) Inventors: Yasuhide KURIMOTO, Kasugai-shi (JP); Hideaki MIYAKE, Nisshin-shi (JP); Junta IZUMI, Nagoya-shi (JP)

(21) Appl. No.: 16/815,202

(22) Filed: Mar. 11, 2020

(30) Foreign Application Priority Data
Mar. 11, 2019 (JP) 2019-043819
Feb. 26, 2020 (JP) 2020-030410

(51) Int. Cl. B60L 53/66; B60L 53/80; B60L 50/60; B60L 58/12; G06Q 30/06; G06Q 50/30; G06Q 20/08; G06Q 50/06

(52) U.S. Cl. CPC B60L 53/665; B60L 53/80; B60L 50/66; B60L 58/12; G06Q 2240/00; G06Q 50/30; G06Q 20/085; G06Q 50/06; G06Q 30/0645

(57) ABSTRACT

A battery lease system lends a battery to a user. The battery lease system includes a vehicle configured to be equipped with the battery for traveling, and a server that manages a lease fee to be paid by the user for lease of the battery. The vehicle permits traveling of the vehicle only for a period in which a capacity retention ratio changes by a specified amount, when the user pays the lease fee, the capacity retention ratio indicating a degree of progress of deterioration of the battery.

This nonprovisional application is based on Japanese Patent Application Nos. 2019-043819 and 2020-030410 filed on Mar. 11, 2019 and Feb. 26, 2020, respectively, with the Japan Patent Office, the entire contents of which are hereby incorporated by reference.

### BACKGROUND

### Field

The present disclosure relates to a battery lending system, a vehicle, a server, and a battery lending method, and more particularly to a technique for lending a battery for traveling mounted on a vehicle to a user.

### Description of the Background Art

Systems for lending (leasing or renting) a battery have been proposed. For example, Japanese Patent Laying-Open No. 2003-288539 discloses a fee charging system that charges a fee for the use of a rental battery pack mounted on an electronic apparatus or a home electric appliance. In the fee charging system for the battery pack, a fee corresponding to the status of use of the rental battery pack, specifically, a fee calculated by multiplying a fee for single charging/discharging by the number of times of charging/discharging, is charged.

### SUMMARY

It is also conceivable to lend a battery for traveling mounted on a vehicle to a user. Only a battery may be lent to a user who owns a vehicle, or a battery may be lent to a user together with a vehicle (a portion other than the battery).

When such a battery lending business is performed, as deterioration of a battery progresses, the economic value of the battery for a business entity that owns the battery (a lease company or a rental company) is reduced. In particular, although it is possible to collect and recycle (i.e., reuse or rebuild as described later) a battery even when it deteriorates to some extent, it is impossible to recycle an excessively deteriorated battery, and its value is significantly reduced. Therefore, it is desirable for the business entity to suppress progress of deterioration of a battery as much as possible.

It is also possible to charge a fee for a battery lent to a user, using the same technique as that of the fee charging system disclosed in Japanese Patent Laying-Open No. 2003-288539. However, the degree of progress of deterioration of a battery is not determined only by the number of times the battery is charged/discharged. For example, depending on the user's driving manner, the battery is charged/discharged with a large current, and deterioration of the battery is more likely to progress. Alternatively, as the environment where a vehicle is located has a higher temperature, deterioration of a battery thereon is more likely to progress. In the technique disclosed in Japanese Patent Laying-Open No. 2003-288539, only the number of times the battery is charged/discharged is considered as a manner of using the battery, and the user is less likely to be aware of deterioration of the battery. Hence, the user has less motivation (incentive) to suppress progress of deterioration of the battery.

The present disclosure has been made to solve the aforementioned problem, and an object thereof is to provide a technique that can suppress (slow) progress of deterioration of a battery mounted on a vehicle, when lending the battery to a user.

(1) A battery lending system according to an aspect of the present disclosure lends a battery to a user. The battery lending system includes a vehicle configured to be equipped with the battery for traveling, and a server that manages a lending fee to be paid by the user for lending of the battery. The vehicle permits traveling of the vehicle only for a period in which an index indicating a degree of progress of deterioration of the battery (such as a capacity retention ratio) changes by a specified amount, when the user pays the lending fee.

In the above feature (1), the use of the vehicle is limited such that progress of deterioration of the battery is allowed by a degree corresponding to the lending fee. This means that, when deterioration of the battery progresses, the user selects whether to pay the lending fee and continue using the battery (the detail thereof will be described later). By imposing a monetary burden on the user with progress of deterioration of the battery in this manner, the user comes to pay attention to the manner of using the vehicle (battery) such that deterioration of the battery may not progress as much as possible. Therefore, according to the above feature (1), progress of deterioration of the battery can be suppressed.

(2) A vehicle according to another aspect of the present disclosure includes a battery for traveling of the vehicle, a communication module that communicates with a server that manages a lending fee to be paid by a user for lending of the battery, and a controller that permits traveling of the vehicle only for a period in which an index indicating a degree of progress of deterioration of the battery changes by a specified amount, when the user pays the lending fee.

(3) The controller prohibits traveling of the vehicle, when the user does not pay the lending fee.

According to the above features (2) and (3), progress of deterioration of the battery can be suppressed, as with the above feature (1).

(4) A server according to another aspect of the present disclosure manages a lending fee to be paid by a user for lending of a battery for traveling mounted on a vehicle. The server includes a communication device that communicates with the vehicle, and a processor that provides the vehicle with a notification for permitting traveling of the vehicle only for a period in which an index indicating a degree of progress of deterioration of the battery changes by a specified amount, when the user pays the lending fee.

According to the above feature (4), progress of deterioration of the battery can be suppressed, as with the above feature (1).

(5) The processor manages the lending fee in association with the index, and determines the lending fee according to the index.

(6) As the index indicates that deterioration of the battery progresses more, the processor decreases the lending fee for the period in which the index changes by the specified amount.

In the above feature (6), as deterioration of the battery progresses more, the lending fee for the period in which the index changes by the specified amount (so to speak, a unit price for the lending fee) becomes lower. Since a distance for which the vehicle can travel (EV travel distance) decreases and the value of the battery is reduced as deterioration of the battery progresses more, according to the above feature (6), the lending fee is discounted accordingly. Thereby, the user can more feel that the lending fee is reasonable.

(7) When the index exceeds a predetermined value as deterioration of the battery progresses, the processor increases the lending fee for the period in which the index changes by the specified amount, when compared with a case where the index is equal to the predetermined value.

When the index exceeds the predetermined value, deterioration of the battery may progress excessively. Therefore, by setting the lending fee to be comparatively expensive when the index exceeds the predetermined value as in the above feature (7), the user is less likely to continue using the vehicle. As a result, the user is more likely to return the battery to a business entity (such as a lease company), and thus the business entity can collect and recycle the battery.

(8) The processor provides the user with first information about a distance for which the vehicle can travel until permission for traveling of the vehicle ends.

According to the above feature (8), providing the user beforehand with the first information about the distance for which the vehicle can travel until permission for traveling of the vehicle ends can prevent a situation in which the vehicle suddenly becomes unable to travel (a so-called surprise situation). Thereby, user satisfaction can be improved.

(9) The processor provides the user with second information for increasing an electric vehicle (EV) travel distance for which the vehicle can travel using power stored in the battery, determined based on a status of use of the battery by the user.

(10) The second information is information about a recommended charging frequency of the battery, determined based on a travel distance per day of the vehicle and the EV travel distance.

(11) The second information is information about a recommended charging manner of the battery including timer charging performed according to a time schedule, determined based on a time for which the battery is left with an SOC of the battery being higher than a reference value.

According to the above features (9) to (11), by providing the user with the second information about the recommended charging frequency or the recommended charging manner, the user can avoid setting the charging frequency to be unnecessarily high, or can utilize timer charging for charging. Although details will be described later, progress of deterioration of the battery can be thereby suppressed, which can decrease the lending fee for the battery. As a result, user satisfaction can be improved.

(12) A battery lending method according to still another aspect of the present disclosure is a method for lending a battery for traveling mountable on a vehicle to a user. The battery lending method includes determining a lending fee to be paid by the user for lending of the battery, and permitting traveling of the vehicle only for a period in which an index indicating a degree of progress of deterioration of the battery changes by a specified amount, when the user pays the lending fee.

According to the above method (12), progress of deterioration of the battery can be suppressed, as with the above feature (1).

The foregoing and other objects, features, aspects, and advantages of the present disclosure will become more apparent from the following detailed description of the present disclosure when taken in conjunction with the accompanying drawings.

### BRIEF DESCRIPTION OF THE DRAWINGS

FIG. 1 is a view showing a battery distribution model in a first embodiment.

FIG. 2 is a view schematically showing an overall configuration of a battery lease system in accordance with the first embodiment.

FIG. 3 is a view showing configurations of a vehicle and a fee charging server in more detail.

FIG. 4 is a view showing an example of a manner of deterioration of a battery.

FIG. 5A is a view (first view) for illustrating a manner of lease of the battery in the first embodiment.

FIG. 5B is a view (second view) for illustrating a manner of lease of the battery in the first embodiment.

FIG. 5C is a view (third view) for illustrating a manner of lease of the battery in the first embodiment.

FIG. 5D is a view (fourth view) for illustrating a manner of lease of the battery in the first embodiment.

FIG. 6 is a view for illustrating a fee plan A.

FIG. 7 is a view showing the relation between a capacity retention ratio of the battery and a lease fee for the battery in fee plan A.

FIG. 8 is a view for illustrating a fee plan B.

FIG. 9 is a view showing the relation between the capacity retention ratio of the battery and the lease fee for the battery in fee plan B.

FIG. 10 is a flowchart showing processing related to lease of the battery in the first embodiment.

FIG. 11 is a conceptual view showing an example of a data structure of battery information.

FIG. 12 is a conceptual view showing an example of a data structure of lease contract information.

FIG. 13 is a flowchart showing processing related to lease of the battery in a variation of the first embodiment.

FIG. 14 is a view showing the relation between the capacity retention ratio of the battery and the lease fee for the battery in a fee plan C.

FIG. 15 is a view showing the relation between the capacity retention ratio of the battery and the lease fee for the battery in a fee plan D.

FIG. 16 is a flowchart showing processing related to lease of the battery in a third embodiment.

FIG. 17 is a flowchart showing an example of information providing processing.

### DESCRIPTION OF THE PREFERRED EMBODIMENTS

Hereinafter, the present embodiment will be described in detail with reference to the drawings. It should be noted that identical or corresponding parts in the drawings will be designated by the same reference numerals, and the description thereof will not be repeated.

In the present disclosure, a battery is a battery assembly including a plurality of modules (also referred to as a plurality of blocks). The plurality of modules may be connected in series, or may be connected in parallel. Each of the plurality of modules includes a plurality of cells (unit cells) connected in series or in parallel.

In the present embodiment, used batteries are collected from a plurality of vehicles, and the collected batteries are recycled. In the following, a manner of distribution from collection of the used batteries to sale of the recycled batteries is referred to as a “battery distribution model”.

Generally, “recycle” of a battery is broadly categorized into reuse, rebuild, and resource recycle. In the case of reuse, collected batteries are subjected to necessary shipment inspection and shipped as they are as reuse products. In the case of rebuild, collected batteries are once disassembled to modules, for example. Then, among the disassembled modules, modules which can be used after reconditioning (which may be modules which can be used as they are) are combined to manufacture a new battery. Newly manufactured batteries are subjected to shipment inspection and shipped as rebuilt products. In contrast, in the case of resource recycle, renewable materials are taken out of each cell and hence collected batteries are not used as other batteries.

“Recycle” of a battery in the present disclosure means reuse or rebuild of a battery. It should be noted that, in the case of rebuild, at least one of a plurality of modules constituting a battery is replaced with another module (replacement module). Although the replacement module is basically a recyclable module taken out of a collected battery, it may be a new module.

### First Embodiment

<Battery Distribution Model>

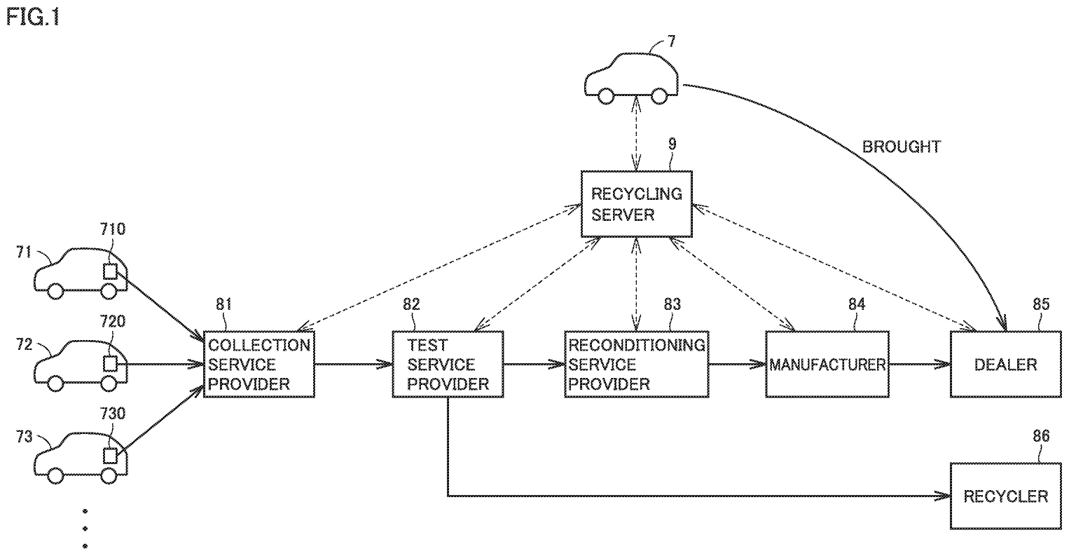

FIG. 1 is a view showing a battery distribution model in a first embodiment. Referring to FIG. 1, in the battery distribution model, used batteries 710 to 730 mounted on vehicles 71 to 73, respectively, are collected. Collected batteries 710 to 730 are recycled through a process handled by a collection service provider 81, a test service provider 82, a reconditioning service provider 83, a manufacturer 84, and a dealer 85 (or a recycler 86). In this process, a variety of information about the batteries is managed by a recycling server 9. Then, a battery mounted on a vehicle 7 of a certain user is replaced with a recycled battery.

More specifically, collection service provider 81 collects used batteries 710 to 730 from vehicles 71 to 73. It should be noted that, although FIG. 1 shows only three vehicles due to space restriction, batteries are actually collected from a larger number of vehicles. Collection service provider 81 disassembles the collected batteries and takes out a plurality of modules from the batteries. Each module is provided with identification information (ID) for identifying the module, and information on each module is managed by recycling server 9. Therefore, collection service provider 81 transmits the ID of each module taken out of a battery to recycling server 9, using a terminal (not shown).

Test service provider 82 tests performance of each module collected by collection service provider 81. Specifically, test service provider 82 tests characteristics of each collected module. For example, test service provider 82 tests electrical characteristics such as a full charge capacity, a resistance value, an open circuit voltage (OCV), and a state of charge (SOC). Then, test service provider 82 classifies the modules into recyclable modules and non-recyclable modules based on test results, passes the recyclable modules to reconditioning service provider 83 and the non-recyclable modules to recycler 86. It should be noted that the test result of each module is transmitted to recycling server 9, using a terminal (not shown) of test service provider 82.

Reconditioning service provider 83 performs processing for reconditioning a module determined as recyclable by test service provider 82. By way of example, reconditioning service provider 83 restores a full charge capacity of the module by charging the module to an overcharged state. However, for a module determined as having less performance degradation in the test by test service provider 82, the reconditioning processing performed by reconditioning service provider 83 may be skipped. The result of reconditioning of each module is transmitted to recycling server 9, using a terminal (not shown) of reconditioning service provider 83.

Manufacturer 84 manufactures a battery, using modules reconditioned by reconditioning service provider 83. In the present embodiment, information for manufacturing a battery (assembly information) is generated by recycling server 9 and transmitted to a terminal (not shown) of manufacturer 84. According to the assembly information, manufacturer 84 manufactures (rebuilds) a battery of vehicle 7 by replacing a module included in the battery of vehicle 7.

Dealer 85 sells the battery manufactured by manufacturer 84 for vehicle use or for stationary use in a house or the like. In the present embodiment, vehicle 7 is brought to dealer 85 and dealer 85 replaces the battery of vehicle 7 with a reuse product or a rebuilt product manufactured by manufacturer 84.

Recycler 86 disassembles a module determined as being non-recyclable by test service provider 82 for reclamation for use as new cells or as source materials for other products.

It should be noted that, although collection service provider 81, test service provider 82, reconditioning service provider 83, manufacturer 84, and dealer 85 are service providers different from one another in FIG. 1, classification of the service providers is not limited as such. For example, a single service provider may serve as test service provider 82 and reconditioning service provider 83. Alternatively, collection service provider 81 may be divided into a service provider which collects batteries and a service provider which disassembles collected batteries. In addition, locations of the service providers and the dealer are not particularly limited. Locations of the service providers and the dealer may be different, or a plurality of service providers or the dealer may be located at the same place.

<Battery Lease System>

In the present embodiment, there is established a system that leases a battery to a user so as to prevent a reduction in the value of the battery and increase the amount of collected recyclable batteries. This system is referred to as a “battery lease system”.

It should be noted that lease and rental are known as transactions in which a party owning an item, such as an apparatus or a facility, lends the item to another. Generally, lease is a transaction in which a lease company purchases an item selected by a person/company as a lessee, and lends the item to the lessee for a relatively long period (usually, for several years). Rental is a transaction in which a rental company lends an item it already owns to a lessee for a period for which the lessee needs the item (usually, for a period shorter than a lease period). Although a description is given below of an example where a battery is leased, the battery may be rented instead of being leased.

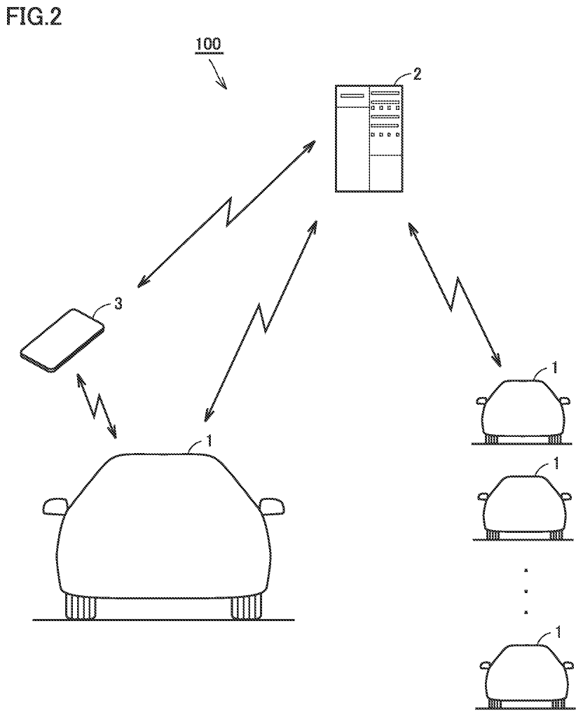

FIG. 2 is a view schematically showing an overall configuration of the battery lease system in accordance with the first embodiment. Referring to FIG. 2, a battery lease system (battery lending system) 100 includes a plurality of vehicles 1 and a fee charging server 2. Each of the plurality of vehicles 1 is configured to bidirectionally communicate with fee charging server 2.

In the following, a description is given focusing on one specific vehicle 1 (vehicle 1 on the left side in the drawing) for simplification of the description. This vehicle 1 is also configured to bidirectionally communicate with a smart phone 3 of a user of vehicle 1. Further, fee charging server 2 is also configured to bidirectionally communicate with smart phone 3.

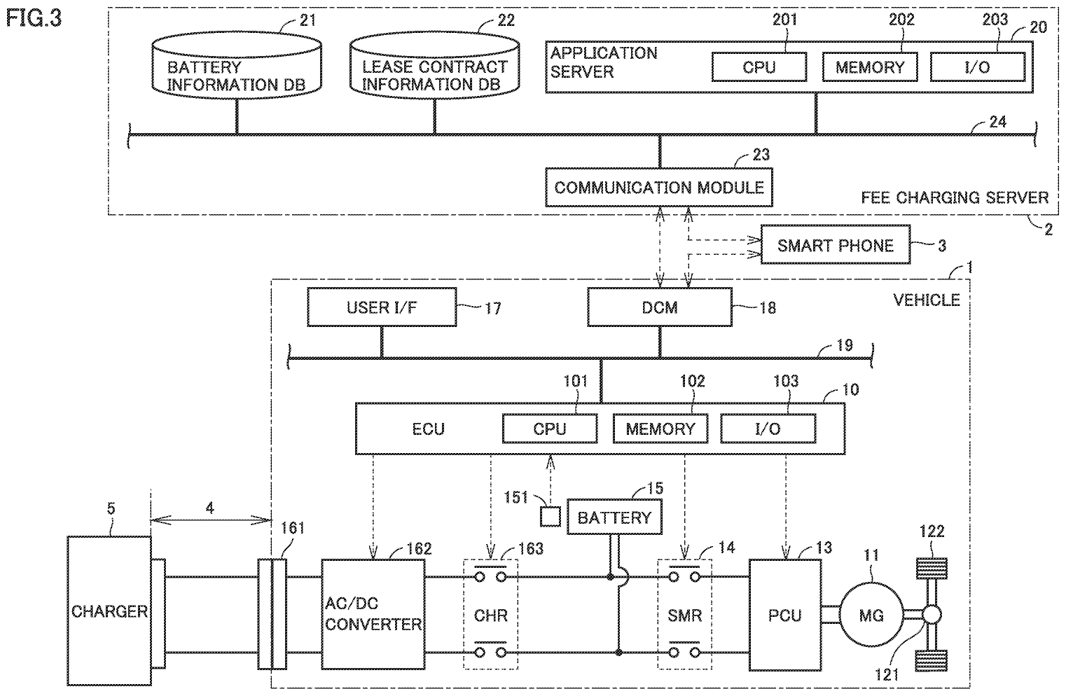

FIG. 3 is a view showing configurations of vehicle 1 and fee charging server 2 in more detail. Referring to FIG. 3, the present embodiment describes an example where vehicle 1 is an electric vehicle. However, vehicle 1 may be another electrically powered vehicle (a hybrid vehicle, a plug-in hybrid vehicle, or a fuel cell vehicle). Vehicle 1 is configured to be electrically connected to a charger 5 outside the vehicle, using a charging cable 4.

Vehicle 1 includes a motor generator 11, a power transmission gear 121, drive wheels 122, a power control unit (PCU) 13, a system main relay (SMR) 14, a battery 15, an inlet 161, an AC/DC converter 162, a charging relay 163, a user interface 17, a data communication module (DCM) 18, a vehicle-mounted network 19, and an electronic control unit (ECU) 10.

Motor generator 11 is an alternating current (AC) rotating electric machine, and is, for example, a permanent magnet-type synchronous motor including a rotor having a permanent magnet embedded therein. The output torque of motor generator 11 is transmitted to drive wheels 122 through power transmission gear 121, to cause vehicle 1 to travel. In addition, during a braking operation of vehicle 1, motor generator 11 can generate electric power using a rotational force of drive wheels 122. The electric power generated by motor generator 11 is converted by PCU 13 into charging power for battery 15.

PCU 13 is configured to include a converter and an inverter (both not shown). PCU 13 converts direct current (DC) power stored in battery 15 into AC power and supplies it to motor generator 11 according to a command from ECU 10. In addition, PCU 13 converts AC power generated by motor generator 11 into DC power and supplies it to battery 15.

SMR 14 is electrically connected to power lines connecting PCU 13 and battery 15. SMR 14 switches supply and interruption of electric power between PCU 13 and battery 15 according to a command from ECU 10.

Battery 15 supplies electric power for generating a drive force for vehicle 1. In addition, battery 15 stores the electric power generated by motor generator 11. Battery 15 is a battery assembly configured to include a plurality of modules. Each of the plurality of modules includes a plurality of cells. In the present embodiment, each cell is a lithium ion secondary battery. It should be noted that, although the electrolyte for the lithium ion secondary battery is a liquid electrolyte, for example, it is not limited to a liquid electrolyte, but may be a polymer electrolyte or an all-solid electrolyte.

Battery 15 is provided with a monitoring unit 151 that monitors the state of battery 15. Specifically, monitoring unit 151 includes a voltage sensor, a current sensor, and a temperature sensor (all not shown). The voltage sensor detects the voltage of battery 15. The current sensor detects a current input/output to/from battery 15. The temperature sensor detects the temperature of battery 15. Each sensor outputs a detection result thereof to ECU 10. ECU 10 calculates an index indicating a state of deterioration of battery 15 based on the detection result from each sensor. This index will be described later.

Inlet 161 is configured such that a charging plug (not shown) of charging cable 4 can be connected thereto.

AC/DC converter 162 is electrically connected to power lines connecting inlet 161 and charging relay 163. AC/DC converter 162 converts AC power supplied from charger 5 through charging cable 4 and inlet 161 into DC power, and outputs it to charging relay 163.

Charging relay 163 is electrically connected to power lines connecting AC/DC converter 162 and battery 15. Charging relay 163 switches supply and interruption of electric power between AC/DC converter 162 and battery 15 according to a command from ECU 10.

It should be noted that the configuration for charging vehicle 1 with the electric power supplied from charger 5 (external charging) is not limited to the configuration shown in FIG. 3. For example, when charger 5 is a charger that supplies DC power (a so-called fast charger), it is not necessary to provide AC/DC converter 162, or a DC/DC converter (not shown) may be provided instead of AC/DC converter 162.

User interface 17 is configured to provide the user with a variety of information about vehicle 1, and receive various operations by the user. User interface 17 is implemented, for example, by a touch panel-equipped monitor of a car navigation system.

DCM 18 is configured to wirelessly bidirectionally communicate with fee charging server 2. DCM 18 is also configured to wirelessly communicate with smart phone 3 of the user of vehicle 1. It should be noted that DCM 18 corresponds to a “communication module” in accordance with the present disclosure.

Vehicle-mounted network 19 is a wired network such as Controller Area Network (CAN), for example, and connects user interface 17, DCM 18, and ECU 10 with one another.

ECU 10 includes a central processing unit (CPU) (or simply a processor) 101, a memory 102 such as a read-only memory (ROM) and/or a random access memory (RAM), and an input/output port 103. ECU 10 controls each device such that vehicle 1 may achieve a desired state, based on an input of a signal from each sensor and a map and a program stored in the memory. Examples of main control to be performed by ECU 10 in the present embodiment include control that limits the use of vehicle 1 according to the result of calculating the index indicating the state of deterioration of battery 15. This control will also be described later. It should be noted that ECU 10 corresponds to a “control device” in accordance with the present disclosure.

Fee charging server 2 is configured to perform arithmetic processing described later based on data about the plurality of vehicles 1. Fee charging server 2 includes a battery information database 21 and a lease contract information database 22 that are each a database server, a communication module 23, an intra-server network 24, and an application server 20. It should be noted that fee charging server 2 corresponds to a “server” in accordance with the present disclosure.

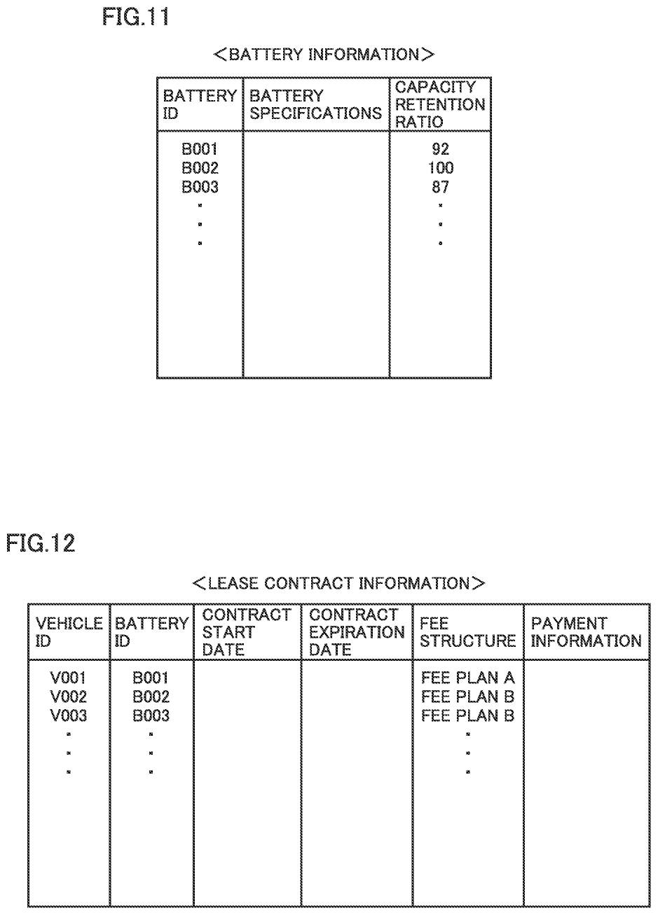

Battery information database 21 stores “battery information” (see FIG. 11), which is information indicating the state of battery 15 mounted on each vehicle 1. Lease contract information database 22 stores “lease contract information” (see FIG. 12), which is information obtained when the user makes a lease contract for battery 15 mounted on each vehicle 1.

Communication module 23 is configured to wirelessly bidirectionally communicate with DCM 18 mounted on vehicle 1. Communication module 23 is also configured to wirelessly communicate with smart phone 3 of the user of vehicle 1. It should be noted that communication module 23 corresponds to a “communication device” in accordance with the present disclosure.

Intra-server network 24 connects battery information database 21, lease contract information database 22, communication module 23, and application server 20 with one another.

Application server 20 includes a CPU (or simply a processor) 201, a memory 202 such as a ROM and/or a RAM, and an input/output port 203, as with ECU 10.

Application server 20 performs a variety of arithmetic processing for leasing battery 15 to the user. Main processing to be performed by application server 20 is processing for managing a lease fee F to be paid by the user for lease of battery 15. This processing will be described in detail later. It should be noted that application server 20 corresponds to a “processor” in accordance with the present disclosure.

<Deterioration of Battery>

In battery lease system 100 configured as described above, battery 15 deteriorates as time elapses or as a travel distance of vehicle 1 increases. Hence, the index indicating the state of deterioration of battery 15 is calculated to recognize the degree of progress of deterioration of battery 15. In the present embodiment, a capacity retention ratio Q of battery 15 is used as the index. Capacity retention ratio Q of battery 15 represents the ratio of a full charge capacity C of battery 15 at present to a full charge capacity CO of battery 15 in an initial state (for example, at the time of manufacturing) (Q=C/CO).

Full charge capacity CO in the initial state is already known from specifications of battery 15. On the other hand, full charge capacity C at present can be calculated as described below. For example, during external charging of vehicle 1, ECU 10 obtains, from monitoring unit 151, the OCV of battery 15 at the start of charging, the OCV of battery 15 at the end of charging, and a charging current amount AAh for battery 15 from the start of charging to the end of charging. Further, ECU 10 converts a difference between the OCV at the start of charging and the OCV at the end of charging into an SOC difference ASOC, with reference to an SOC-OCV curve stored beforehand in memory 102. Then, ECU 10 calculates full charge capacity C of battery 15 according to the following equation (1) indicating that the ratio between SOC difference ASOC and charging current amount AAh is equal to the ratio between the SOC difference=100% and full charge capacity C:

C=ΔAh/ΔSOC×100 (1)

The timing for calculating capacity retention ratio Q of battery 15 is not limited to during external charging of vehicle 1, and may be other than during external charging (such as during normal traveling of vehicle 1). For example, ECU 10 obtains information about temperature frequency distribution of battery 15, SOC frequency distribution of battery 15, a distance for which vehicle 1 can travel using electric power stored in battery 15 (so-called EV travel distance), a current load and charging current amount ΔAh for battery 15, and the like, and sequentially stores the information in memory 102. By determining the influence of these parameters on capacity retention ratio Q (the correlation between each parameter and capacity retention ratio Q) beforehand by a prior experiment, a decreased amount of capacity retention ratio Q can be calculated from each parameter described above, and capacity retention ratio Q at present can be calculated.

It should be noted that, as the index indicating the state of deterioration of battery 15, instead of or in addition to capacity retention ratio Q of battery 15, full charge capacity C (unit: Ah or Wh) of battery 15 may be used, or the EV travel distance (unit: km) of vehicle 1 may be used.

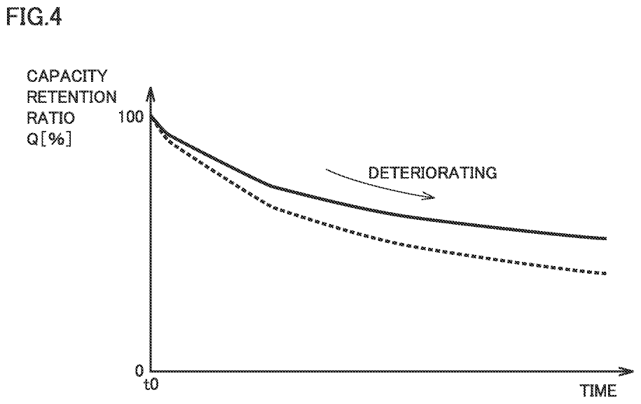

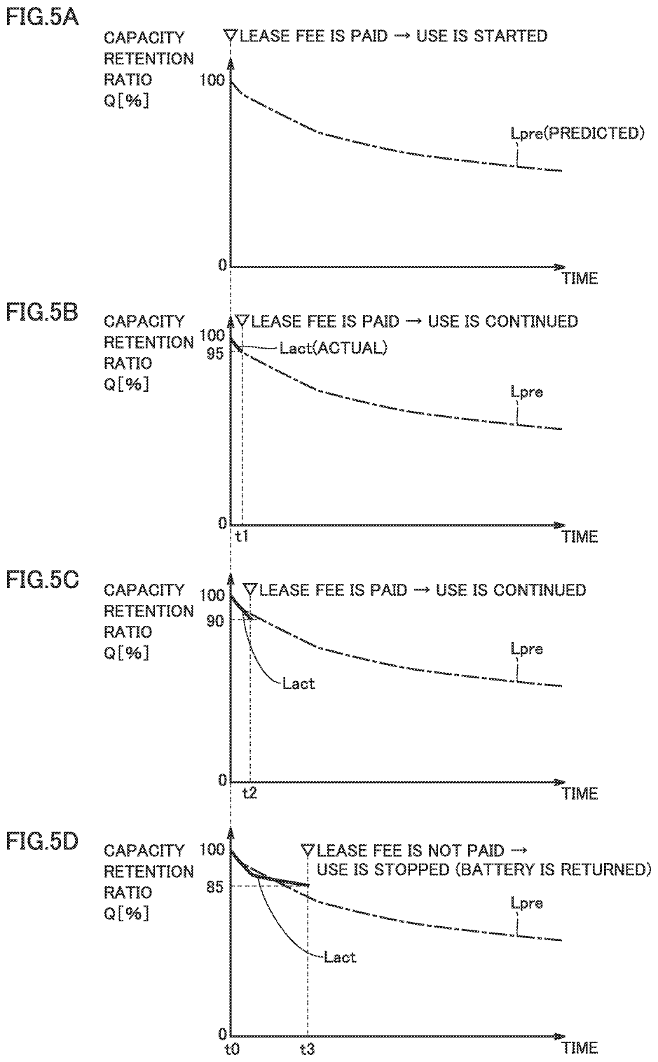

FIG. 4 is a view showing an example of a manner of deterioration of battery 15. In FIG. 4 and FIGS. 5A to 5D described later, the axis of abscissas represents an elapsed time from the initial state of battery 15. The axis of abscissas may be read as the travel distance of vehicle 1. The axis of ordinates represents capacity retention ratio Q of battery 15.

In FIG. 4, the manner in which capacity retention ratio Q of battery 15 mounted on certain vehicle 1 decreases is indicated by a solid line. However, the decrease rate (decreased amount per unit time) of capacity retention ratio Q may differ depending on the manner of using battery 15. For example, depending on the user's driving manner, battery 15 is charged/discharged with a large current, and the decrease rate of capacity retention ratio Q becomes faster, as indicated by a dotted line. Alternatively, as the environment where vehicle 1 is located has a higher temperature, the decrease rate of capacity retention ratio Q becomes faster.

As deterioration of battery 15 progresses, the economic value of battery 15 for a rental company that owns battery 15 is reduced. As described in FIG. 1, it is possible to collect and recycle (rebuild) battery 15 even when it deteriorates to some extent. However, excessively deteriorated battery 15 has no choice but to be allocated to resource recycle. Hence, it is desirable to suppress excessive deterioration of battery 15, and thereby maintain the economic value of the battery and increase the amount of collected recyclable batteries 15. On the other hand, in a common car lease, a lease fee is determined according to a period set by a lease contract for a vehicle (in addition thereto or instead thereof, a maximum travel distance of the vehicle), and thus the user has less motivation (incentive) to suppress progress of deterioration of the battery.

Accordingly, in the present embodiment, a decrease of capacity retention ratio Q of battery 15 is allowed by an amount corresponding to a lease fee (corresponding to a “lending fee” in the present disclosure) paid by the user to a lease company. Then, when capacity retention ratio Q that decreases as vehicle 1 is used reaches a lower limit value of a range allowed corresponding to the lease fee, charging/discharging of battery 15 is prohibited so as to prevent a further decrease of capacity retention ratio Q, unless the user pays an additional lease fee. That is, vehicle 1 becomes unable to travel. Therefore, the user attempts to slow the decrease rate of capacity retention ratio Q as much as possible so as to reduce payment of the lease fee, and thereby deterioration of battery 15 is suppressed. As a result, excessive deterioration of battery 15 can be suppressed, the economic value of battery 15 can be maintained, and the amount of collected recyclable batteries 15 can be increased.

<Permission to Use Vehicle and Stop of Use of Vehicle>

FIGS. 5A to 5D are views for illustrating manners of lease of battery 15 in the first embodiment. In FIGS. 5A to 5D, a predicted curve Lpre representing a typical manner in which capacity retention ratio Q of battery 15 decreases is indicated by a dash-dot line. This example describes a case where battery 15 mounted on vehicle 1 is a new battery, and capacity retention ratio Q of battery 15 at a start time t0 is 100%. However, battery 15 may be a used battery (that is, capacity retention ratio Q thereof at start time t0 is less than 100%).

Referring to FIG. 5A, first, a lease contract is made between the user and the lease company. When the user pays an initial lease fee according to the lease contract (or when the user agrees to make payment), the user is permitted to start using vehicle 1. In this example, the user is allowed to use vehicle 1 for a period in which capacity retention ratio Q decreases from 100% to 95%.

As vehicle 1 is used, capacity retention ratio Q of battery 15 decreases. In the example shown in FIG. 5B, actual capacity retention ratio Q (indicated by a solid line designated as Lact) decreases following predicted curve Lpre, and reaches Q=95% at a time tl. Then, the user of vehicle 1 receives an inquiry as to whether to pay a lease fee for a period in which capacity retention ratio Q decreases from 95% to 90%. When the user pays the lease fee, the user is allowed to use vehicle 1 for the period in which capacity retention ratio Q decreases from 95% to 90%.

Subsequently, referring to FIG. 5C, in this example, the decrease rate of capacity retention ratio Q after time tl is faster than the decrease rate of capacity retention ratio Q following predicted curve Lpre, and reaches Q=90% at a time t2. Then, the user again receives an inquiry as to whether to pay a lease fee for a next period (a period in which capacity retention ratio Q decreases from 90% to 85%). When the user pays the lease fee, the user is allowed to use vehicle 1 also for this period.

Finally, referring to FIG. 5D, the decrease rate of capacity retention ratio Q after time t2 is slower than the decrease rate of capacity retention ratio Q following predicted curve Lpre, and reaches Q=85% at a time t3. Also on this occasion, the user receives an inquiry as to whether to pay a lease fee for a next period (a period in which capacity retention ratio Q decreases from 85% to 80%). In this example, the user does not pay the lease fee. As a result, vehicle 1 becomes unable to travel, and the user is not allowed to use vehicle 1.

As described above, in the present embodiment, when the user pays beforehand a lease fee for a period in which capacity retention ratio Q decreases by a predetermined specified amount (5% in the example of FIGS. 5A to 5D) (hereinafter also referred to as a “deterioration period”), the user is allowed to use vehicle 1 for the deterioration period. On the other hand, when the user does not pay the lease fee, the user is not allowed to use vehicle 1. In this case, vehicle 1 is returned to the lease company that owns battery 15. The lease company can collect battery 15 from returned vehicle 1. Then, the lease company can determine whether to recycle collected battery 15 according to the degree of progress of deterioration of battery 15.

It should be noted that FIGS. 5A to 5D describe an example where a 5% decrease of capacity retention ratio Q is allowed each time the user pays the lease fee. However, the numerical value of 5% is merely an example, and the numerical value may be set as appropriate. In addition, it is not essential that the decreased amount of capacity retention ratio Q is a constant value, and the decreased amount of capacity retention ratio Q may be set to a different value for each deterioration period, or the user may be allowed to select the decreased amount of capacity retention ratio Q.

<Lease Fee Structure>

As a fee structure for lease fee F, a plurality of structures (plans) can be introduced as described below. In the present embodiment, by way of example, a fee plan A and a fee plan B are introduced.

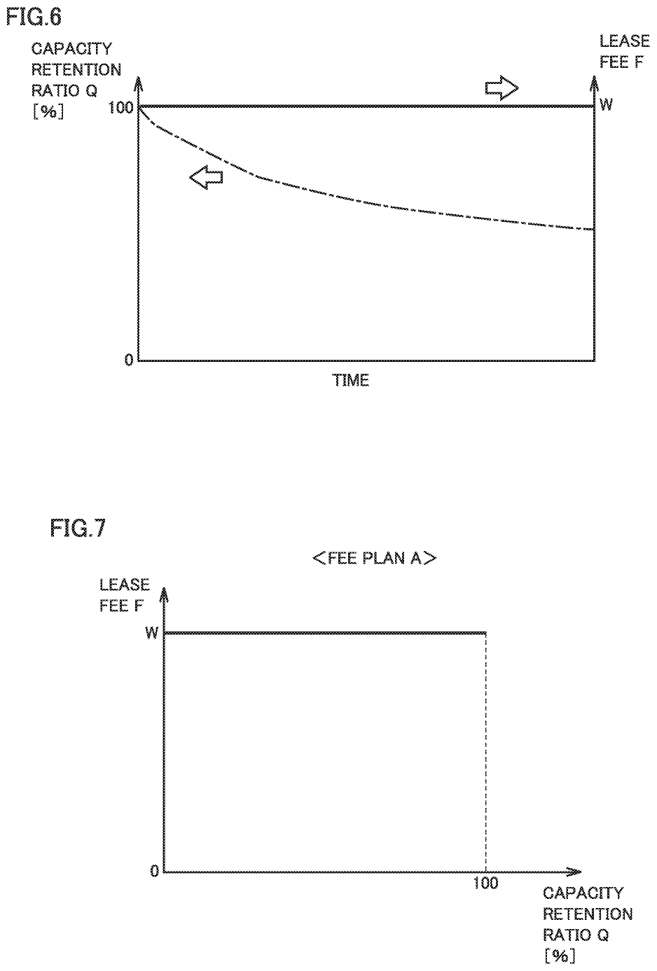

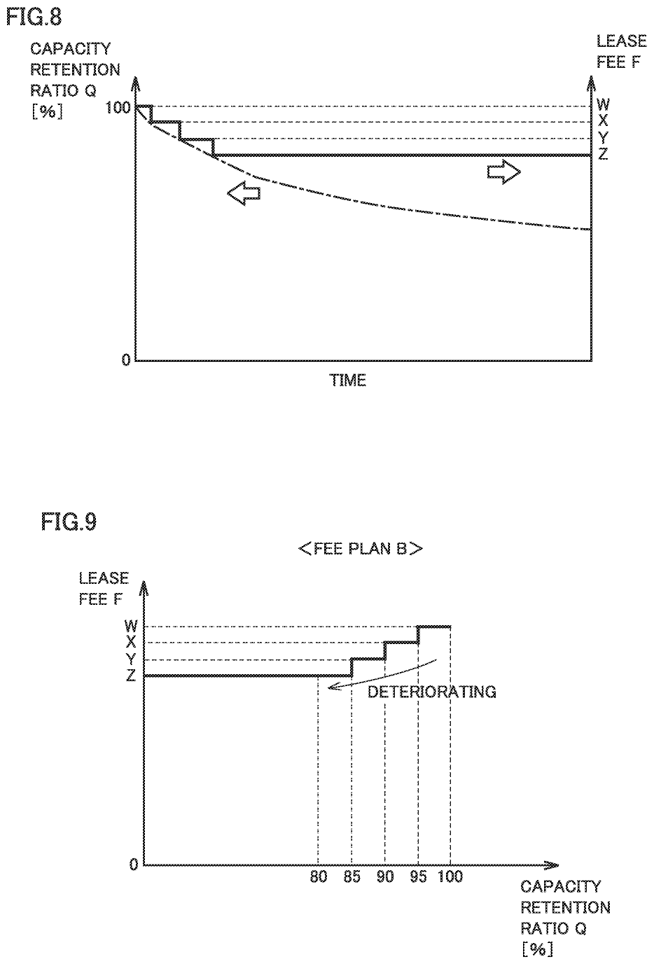

FIG. 6 is a view for illustrating fee plan A. In FIG. 6 and FIG. 8 described later, the axis of abscissas represents an elapsed time. The axis of ordinates on the left side represents capacity retention ratio Q of battery 15. The axis of ordinates on the right side represents lease fee F for battery 15.

FIG. 7 is a view showing the relation between capacity retention ratio Q of battery 15 and lease fee F for battery 15 in fee plan A. In FIG. 7 and FIGS. 9, 14, and 15 described later, the axis of abscissas represents capacity retention ratio Q of battery 15. The axis of ordinates represents lease fee F for battery 15.

As shown in FIGS. 6 and 7, in fee plan A, lease fee F is constant irrespective of capacity retention ratio Q. In contrast, in fee plan B, lease fee F for a period in which capacity retention ratio Q decreases by the specified amount (deterioration period) is set to a value corresponding to capacity retention ratio Q.

FIG. 8 is a view for illustrating fee plan B. FIG. 9 is a view showing the relation between capacity retention ratio Q of battery 15 and lease fee F for battery 15 in fee plan B.

Referring to FIGS. 8 and 9, in fee plan B, lease fee F becomes lower as capacity retention ratio Q of battery 15 decreases. More specifically, lease fee F for a period in which capacity retention ratio Q ranges from 100% to 95% is set to W. Lease fee F for a period in which capacity retention ratio Q ranges from 95% to 90% is set to X that is lower than W (W>X). Lease fee F for a period in which capacity retention ratio Q ranges from 90% to 85% is set to Y that is further lower than X (W>X>Y). Lease fee F for a period in which capacity retention ratio Q falls below 85% is set to Z that is the lowest (W>X>Y>Z).

As capacity retention ratio Q of battery 15 decreases, the EV travel distance of vehicle 1 decreases, and thus the value of battery 15 is reduced. Therefore, by setting lease fee F to become lower with a decrease in capacity retention ratio Q as in fee plan B, the user can more feel that lending fee F is reasonable.

It should be noted that it is not essential to prepare two fee plans A and B as in the present embodiment, and only fee plan A may be prepared, or only fee plan B may be prepared.

<Flow of Lease of Battery>

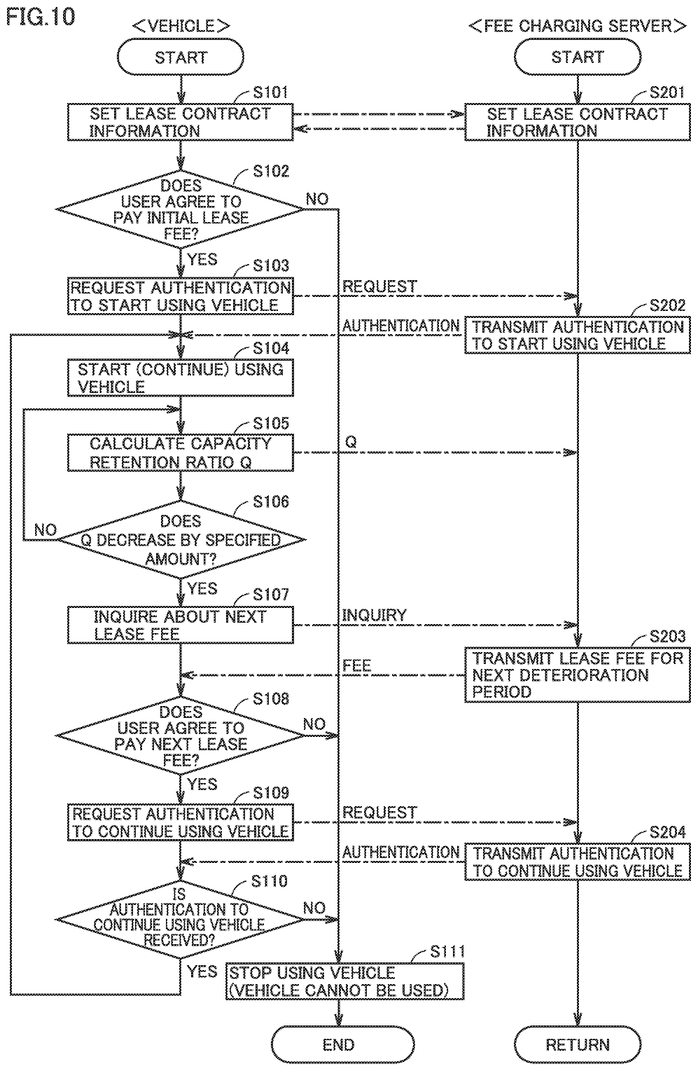

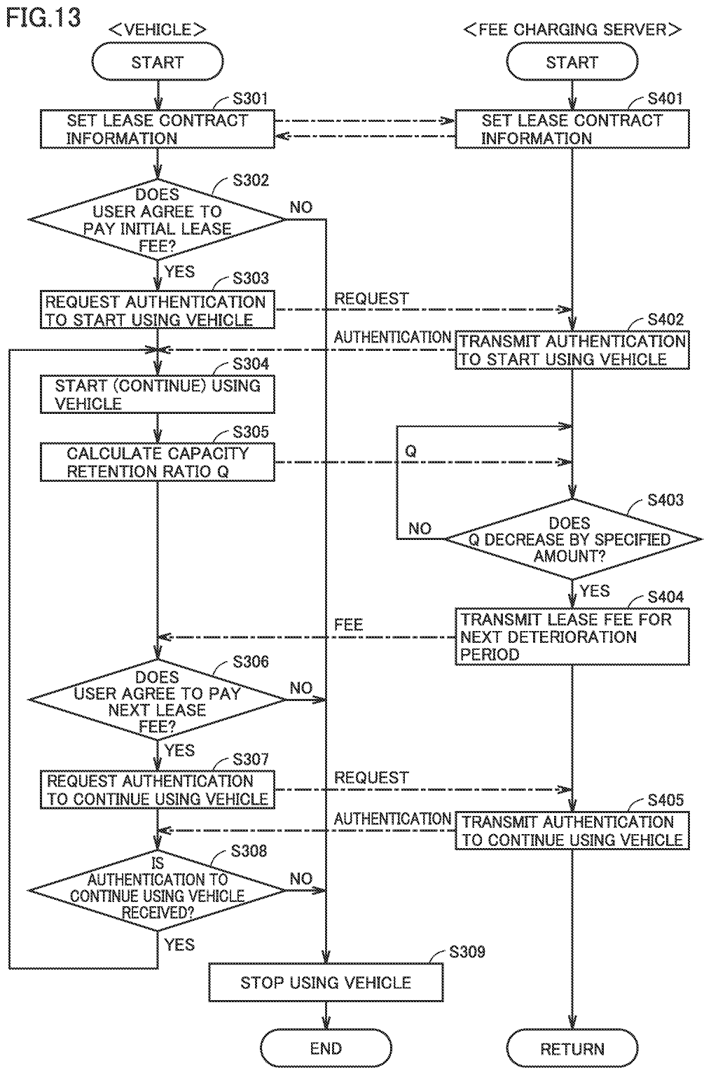

FIG. 10 is a flowchart showing processing related to lease of the battery in the first embodiment. In FIG. 10 and FIG. 13 described later, a series of processings to be performed by ECU 10 of vehicle 1 is shown on the left side of the drawing, and a series of processings to be performed by application server 20 of fee charging server 2 is shown on the right side of the drawing. It should be noted that, in the following, for the sake of simplification, the subject that performs the step to be performed by ECU 10 may be described as vehicle 1, and the subject that performs the step to be performed by application server 20 may be described as fee charging server 2. Although each step is implemented by software processing by vehicle 1 (ECU 10) or fee charging server 2 (application server 20), it may be implemented by dedicated hardware (electric circuitry) fabricated within vehicle 1 or fee charging server 2.

Referring to FIGS. 2, 3, and 10, the series of processings to be performed by vehicle 1 shown on the left side of the drawing is performed for example when a predetermined condition is satisfied (for example, when the user of vehicle 1 performs an operation indicating that the user wants to lease vehicle 1, using user interface 17, which is a touch panel-equipped monitor or the like). The series of processings to be performed by fee charging server 2 shown on the right side of the drawing is periodically performed each time a predetermined control cycle elapses, for example.

First, vehicle 1 and fee charging server 2 perform processing for making a lease contract for vehicle 1 by mutually communicating required information (S101, S201). More specifically, in fee charging server 2, battery information is stored in battery information database 21 and lease contract information is stored in lease contract information database 22, as described above.

FIG. 11 is a conceptual view showing an example of a data structure of the battery information. Referring to FIG. 11, the battery information includes, for example, an identification number for identifying each battery 15 (battery ID), information about specifications of each battery 15 (for example, such as the manufacturer, the model number, the number of modules connected in series/parallel and connection relation thereof, the maximum allowable voltage, the maximum allowable current, and the operating temperature range of each battery 15) (battery specifications), and information about capacity retention ratio Q of each battery 15. The information about capacity retention ratio Q is updated as appropriate based on information received for example during external charging of vehicle 1 (or a vehicle on which battery 15 has been mounted, when battery 15 is a used battery).

FIG. 12 is a conceptual view showing an example of a data structure of the lease contract information. Referring to FIG. 12, the lease contract information includes, for example, an identification number for identifying each vehicle 1 (vehicle ID), an battery ID, information about a start date of the lease contract, information about an expiration date of the lease contract, information about a fee structure of the lease contract, and payment information of the user. The information about the fee structure is information that defines the relation between capacity retention ratio Q and lease fee F, and specifically is information such as fee plan A, fee plan B, or the like. The payment information of the user is registered information such as a bank account, a credit card, or the like of the user for paying a lease fee for vehicle 1.

The user inputs his or her desired contract start date and contract expiration date, and selects a desired fee structure (fee plan). The user also registers his or her payment information. Then, vehicle 1 transmits each information described above input by the user to fee charging server 2, together with its vehicle ID and battery ID. Based on the information from vehicle 1, fee charging server 2 registers the lease contract information for a new user, or updates the lease contract information for an already registered user.

Returning back to FIG. 10, in S102, the user performs an operation indicating whether or not the user agrees to pay an initial lease fee (a lease fee for the deterioration period in which capacity retention ratio Q decreases from 100% to 95%), on user interface 17. Based on the result of the operation on user interface 17, vehicle 1 determines whether the user agrees to pay the initial lease fee. It should be noted that, in S102 (and S108 described later), the user may perform the operation on smart phone 3 instead of user interface 17.

When the user does not agree to pay the initial lease fee (NO in S102), vehicle 1 advances the processing to S111. In S111, to start using vehicle 1 is not permitted, and thus vehicle 1 is unable to travel. For example, an ignition-on (IG-ON) operation for vehicle 1 cannot be performed, and thereby charging/discharging of battery 15 is prohibited.

When the user agrees to pay the initial lease fee (YES in S102), vehicle 1 requests an authentication (corresponding to a “notification” in the present disclosure) to start using vehicle 1, from fee charging server 2 (S103). Well-known techniques in the field of electronic authentication (digital authentication) can be used for this authentication. Upon receiving a request from vehicle 1, fee charging server 2 confirms whether it may provide the user with permission to use vehicle 1. For example, fee charging server 2 refers to the lease contract information, and confirms whether the user has the ability to pay based on the lease contract information (information such as the registered account, credit card, or the like of the user). Then, when fee charging server 2 determines that it may provide the user with permission to use vehicle 1, fee charging server 2 transmits an authentication for permission to start using vehicle 1, to vehicle 1 (S202). Upon receiving the authentication from fee charging server 2, vehicle 1 is allowed to be used (S104). Specifically, an IG-ON operation for vehicle 1 can be performed and charging/discharging of battery 15 is permitted, and thereby vehicle 1 becomes able to travel.

Thereafter, as vehicle 1 is used, capacity retention ratio Q of battery 15 gradually decreases. Vehicle 1 calculates capacity retention ratio Q of battery 15 (S105), and determines whether calculated capacity retention ratio Q decreases by a specified amount (S106). This specified amount is set to 5% in the example shown in FIGS. 5A to 5D, and it is determined whether capacity retention ratio Q decreases from 100% to 95% in a first deterioration period. When capacity retention ratio Q does not decrease by the specified amount (NO in S106), vehicle 1 returns the processing to S105. Thereby, the processings in S105 and S106 are repeatedly performed.

When capacity retention ratio Q decreases by the specified amount (YES in S106), vehicle 1 inquires of fee charging server 2 about a lease fee for a next deterioration period in which capacity retention ratio Q decreases by the specified amount (for example, a period in which capacity retention ratio Q decreases from 95% to 90%) (S107). In response to an inquiry from vehicle 1, fee charging server 2 calculates the lease fee for the next deterioration period according to the fee plan (fee plan A or B) contracted by the user, and returns the result of calculation to vehicle 1 (S203). Since the method for calculating this lease fee is described in detail in FIGS. 6 to 9, the description thereof is not repeated here. Vehicle 1 presents the lease fee received from fee charging server 2 to the user, and determines whether the user agrees to pay the lease fee (S108).

When the user agrees to pay the lease fee (YES in S108), vehicle 1 requests an authentication to continue using vehicle 1 also in a next deterioration period, from fee charging server 2 (S109). Upon receiving a request from vehicle 1, fee charging server 2 performs the same processing as the processing in S202. Specifically, fee charging server 2 determines whether it may provide the user with permission to use vehicle 1, based on whether the user has the ability to pay.

When fee charging server 2 determines that it may provide the user with permission to use vehicle 1, fee charging server 2 transmits an authentication for permitting the user to continue using vehicle 1, to vehicle 1 (S204). Upon receiving the authentication from fee charging server 2 (YES in S110), vehicle 1 returns the processing to S104. Thereby, the user is allowed to continue using vehicle 1. Thereafter, the processings in S104 to S110 are repeatedly performed.

In contrast, when the user does not agree to pay the lease fee (NO in S108), vehicle 1 advances the processing to S111. In S111, permission to use vehicle 1 is denied, and thus vehicle 1 becomes unable to travel. As a result, vehicle 1 is returned to the lease company.

However, if vehicle 1 suddenly becomes unable to travel, there may be a case where the user cannot return vehicle 1 to the lease company. Therefore, vehicle 1 may give the user a certain postponement until vehicle 1 becomes unable to travel, even when the user does not agree to pay the lease fee. For example, vehicle 1 can be configured to travel for a predetermined period (for example, for several days) or for a predetermined distance (for example, for several tens to several hundreds of kilometers) after the user performs an operation indicating that the user does not agree to pay the lease fee for the next deterioration period.

As described above, in the first embodiment, each time capacity retention ratio Q of battery 15 decreases by the specified amount, the user selects whether to pay lease fee F and continue using vehicle 1 also in the next deterioration. Since this imposes a monetary burden on the user with a decrease in capacity retention ratio Q, the user comes to pay attention to the manner of using vehicle 1 such that capacity retention ratio Q may not decrease as much as possible. For example, the user drives vehicle 1 so as to avoid charging/discharging battery 15 with a large current, and stores vehicle 1 so as to suppress progress of deterioration of battery 15 under a high temperature environment. Thereby, excessive deterioration of battery 15 can be suppressed.

[Variation]

The first embodiment describes an example where vehicle 1 inquiries of fee charging server 2 about a lease fee for a next deterioration period when capacity retention ratio Q of battery 15 decreases by a specified amount. A variation thereof describes an example where fee charging server 2 manages whether capacity retention ratio Q decreases by a specified amount.

FIG. 13 is a flowchart showing processing related to lease of the battery in the variation of the first embodiment. Referring to FIG. 13, since processings in S301 to

S304, S401, and S402 are the same as the processings in S101 to S104, S201, and S202 in the first embodiment (see FIG. 10), respectively, the description thereof will not be repeated.

In S305, vehicle 1 permitted to come into use calculates (determines) capacity retention ratio Q of battery 15, and transmits the result of calculation to fee charging server 2. Then, fee charging server 2 determines whether capacity retention ratio Q decreases by the specified amount (S403). Vehicle 1 transmits capacity retention ratio Q to fee charging server 2 periodically, for example, and fee charging server 2 waits until capacity retention ratio Q decreases by the specified amount (NO in S403).

When capacity retention ratio Q decreases by the specified amount (YES in S403), fee charging server 2 transmits a lease fee for a next deterioration period to vehicle 1 (S404). This processing is the same as the processing in S203 in the first embodiment.

It should be noted that fee charging server 2 may provide information about a lease fee for a next deterioration period to vehicle 1 without waiting for capacity retention ratio Q of battery 15 to actually decrease by the specified amount. More specifically, fee charging server 2 can estimate a future decrease rate of capacity retention ratio Q from a past decrease rate of capacity retention ratio Q of battery 15 mounted on vehicle 1. Therefore, fee charging server 2 may transmit a lease fee for a next deterioration period to vehicle 1 before an actually measured value of capacity retention ratio Q decreases by the specified amount (for example, a predetermined period earlier than a time point at which it is estimated that capacity retention ratio Q decreases by the specified amount). This can give the user a temporal postponement for determining whether the user continues using vehicle 1.

When the user agrees to pay the lease fee in S306 (YES in S306), vehicle 1 requests an authentication to continue using vehicle 1 also in the next deterioration period, from fee charging server 2 (S307). Subsequent processings in S308, S309, and S405 are also the same as the processings in S110, S111, and S204 in the first embodiment.

As described above, in the variation of the first embodiment, fee charging server 2 determines whether capacity retention ratio Q of battery 15 decreases by the specified amount. Also in the variation of the first embodiment, excessive deterioration of battery 15 can be suppressed, as in the first embodiment.

### Second Embodiment

FIGS. 8 and 9 describe fee plan B in which lease fee F becomes lower as capacity retention ratio Q of battery 15 decreases. According to fee plan B, a decrease in the EV travel distance of vehicle 1 due to deterioration of battery 15 is reflected in lease fee F, and thus the user can more feel that lending fee F is reasonable. On the other hand, from the viewpoint of preventing excessive deterioration of battery 15, it is also possible to adopt other fee structures. In a second embodiment, fee plans C and D are further introduced in addition to (or instead of) fee plans A and B.

It should be noted that, since a flowchart showing processing related to lease of the battery in the second embodiment is the same as the flowchart in the first embodiment or the variation thereof (see FIG. 10 or 13), a detailed description thereof will not be repeated.

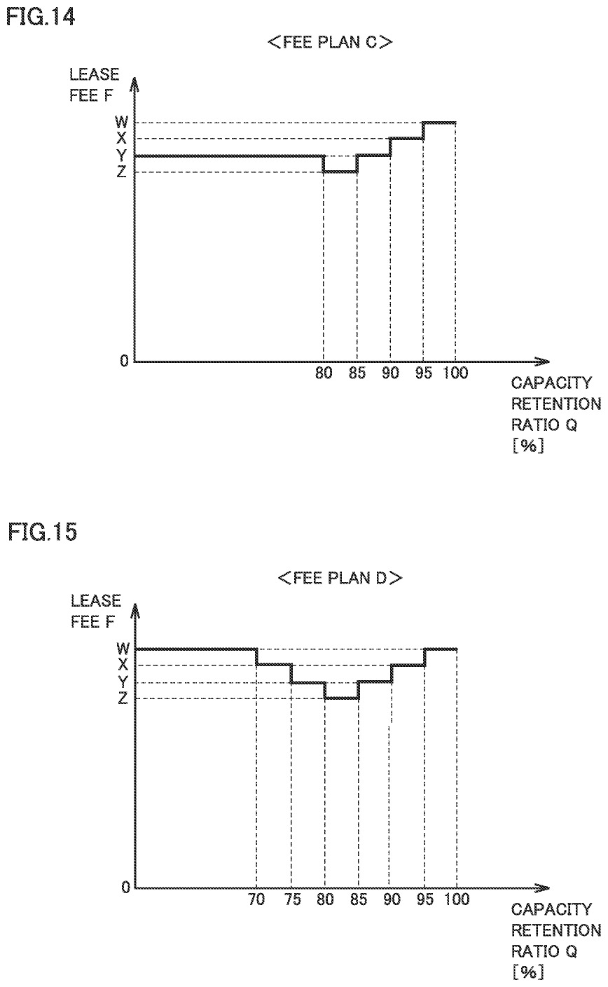

FIG. 14 is a view showing the relation between capacity retention ratio Q of battery 15 and lease fee F for battery 15 in fee plan C. Referring to FIG. 14, in fee plan C, in an early stage of deterioration of battery 15, lease fee F becomes lower as capacity retention ratio Q of battery 15 decreases, as in fee plan B. More specifically, lease fee F for a period in which capacity retention ratio Q ranges from 100% to 95% is set to W. Lease fee F for a period in which capacity retention ratio Q ranges from 95% to 90% is set to X that is lower than W. Lease fee F for a period in which capacity retention ratio Q ranges from 90% to 85% is set to Y that is further lower than X. Lease fee F for a period in which capacity retention ratio Q ranges from 85% to 80% is set to Z that is the lowest.

As described in FIG. 9, in fee plan B, lease fee F is set to lowest fee Z also after capacity retention ratio Q falls below 80%. In contrast, in fee plan C, lease fee F after capacity retention ratio Q falls below 80% is set to be higher than lowest fee Z, and is set to Y in the example shown in FIG. 14.

When lease fee F is set high even though the decrease of capacity retention ratio Q of battery 15 progresses and the EV travel distance of vehicle 1 decreases as described above, the user has to pay, for battery 15 having a reduced value, a fee higher than the amount of money that is commensurate with the value. Hence, the user is motivated to stop using vehicle 1 (cancel lease of vehicle 1) and return vehicle 1 to the lease company. Thereby, the lease company can collect battery 15 before deterioration thereof progresses excessively, and determine whether to recycle collected battery 15.

FIG. 15 is a view showing the relation between capacity retention ratio Q of battery 15 and lease fee F for battery 15 in fee plan D. Referring to FIG. 15, in fee plan D, after capacity retention ratio Q falls below 80%, lease fee F becomes higher as capacity retention ratio Q decreases. More specifically, lease fee F for a period in which capacity retention ratio Q ranges from 80% to 75% is set to Y. Lease fee F for a period in which capacity retention ratio Q ranges from 75% to 70% is set to X. When capacity retention ratio Q falls below 70%, lease fee F is set to W that is the highest.

According to fee plan D, as deterioration of battery 15 progresses, lease fee F becomes relatively higher with respect to the amount of money that is commensurate with the value of battery 15 (in other words, lease fee F is comparatively expensive). Hence, as deterioration of battery 15 progresses, the user is more motivated to cancel lease of vehicle 1 and return vehicle 1 to the lease company. Thereby, the lease company can further increase the number of batteries collected before deterioration thereof progresses excessively (the amount of collected batteries).

As described above, according to the second embodiment, each time capacity retention ratio Q of battery 15 decreases by 5%, a monetary burden in a next deterioration period is imposed on the user. Thus, the user comes to use vehicle 1 such that capacity retention ratio Q may not decrease as much as possible. Thereby, excessive deterioration of battery 15 can be suppressed.

Further, in the second embodiment, when the decrease of capacity retention ratio Q of battery 15 exceeds a predetermined value (80% in the example of FIGS. 14 and 15), lease fee F is set higher than that when capacity retention ratio Q is equal to the predetermined value. Thus, by intentionally producing a deviation between the value of battery 15 and lease fee F for battery 15, the user is motivated to return vehicle 1 to the lease company. Thereby, the amount of collected batteries 15 can be increased (i.e., the rate of collecting batteries 15 can be improved).

### Third Embodiment

A third embodiment will describe a configuration of providing information about end of lease of battery 15 or information for increasing an EV distance of vehicle 1, from fee charging server 2 to vehicle 1 (user).

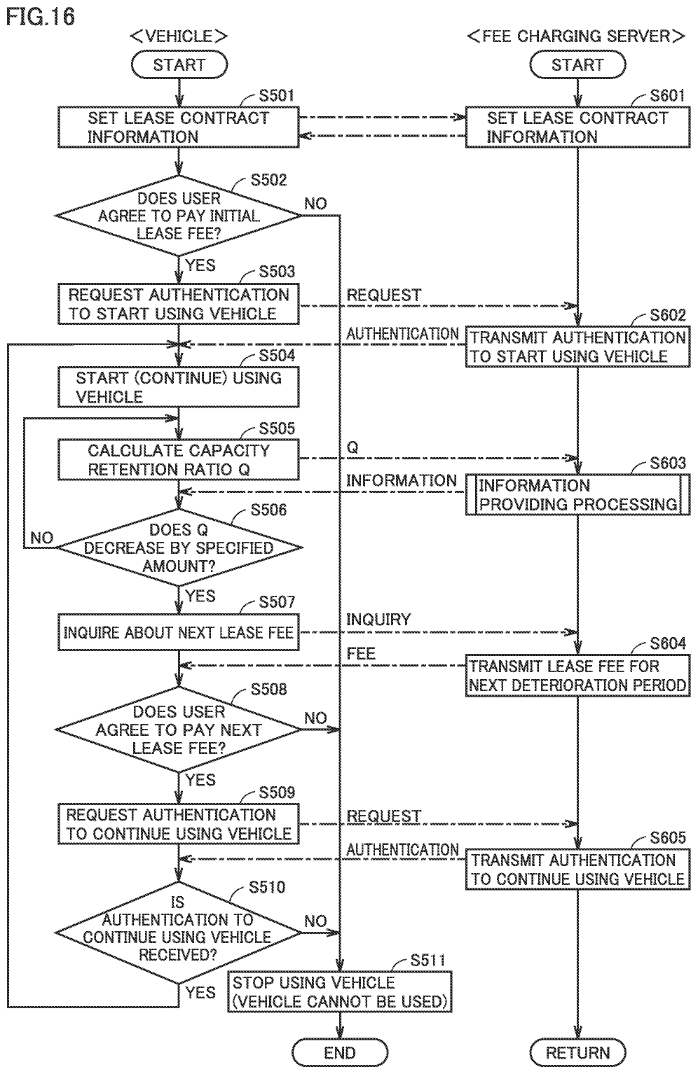

FIG. 16 is a flowchart showing processing related to lease of the battery in the third embodiment. Referring to FIG. 16, this flowchart is different from the flowchart in the first embodiment (see FIG. 10) in that it further includes information providing processing in S603. Since the processings other than that are the same as the corresponding processings in the first embodiment, the description thereof is not repeated.

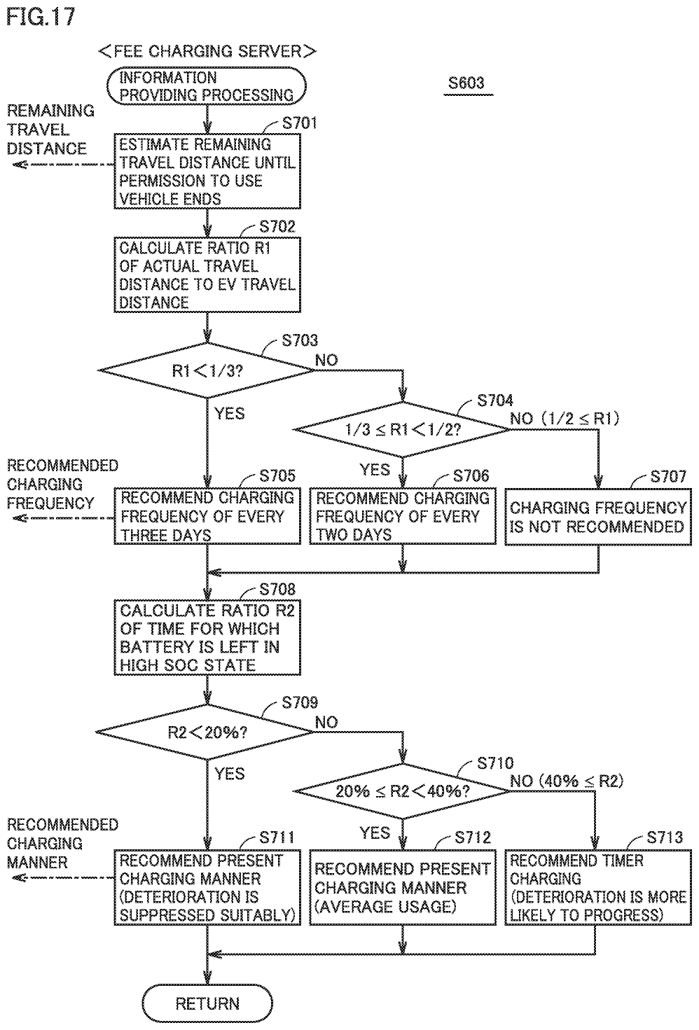

In S505, vehicle 1 calculates capacity retention ratio Q of battery 15, and transmits the result of calculation to fee charging server 2. Fee charging server 2 performs information providing processing, using reception of information about capacity retention ratio Q from vehicle 1 as a trigger in this example. Fee charging server 2 transmits information obtained as a result of information providing processing to vehicle 1 (S603). Details of information providing processing will be described in FIG. 17.

It should be noted that the timing for performing information providing processing is not limited to upon reception of capacity retention ratio Q. Information providing processing may be performed each time a predetermined period elapses (such as per day, per week, per month, or per half a year), for example. The destination of the information obtained by information providing processing is not limited to vehicle 1, and may be smart phone 3 of the user. Further, the above information may be provided to the user by a web service that can be viewed by the user using a personal computer (PC) at a house or the like.

FIG. 17 is a flowchart showing an example of information providing processing. Although not shown, information about the SOC of battery 15 is periodically transmitted from vehicle 1 to fee charging server 2.

Referring to FIG. 17, in S701, fee charging server 2 estimates a distance for which vehicle 1 can travel until permission to use vehicle 1 ends (lease of battery 15 ends). Hereinafter, this distance is also referred to as a “remaining travel distance”. The remaining travel distance of vehicle 1 can be estimated as described below, for example.

Fee charging server 2 has predicted curve Lpre representing a typical manner in which capacity retention ratio Q of battery 15 decreases (see FIGS. 5A to 5D) in memory 202 beforehand. Fee charging server 2 corrects predicted curve Lpre based on actual capacity retention ratio Q received from vehicle 1. For example, when actual capacity retention ratio Q at a certain time is lower than capacity retention ratio Q on predicted curve Lpre at the same time, fee charging server 2 corrects predicted curve Lpre downward (in a direction in which the future decrease rate of capacity retention ratio Q increases). Conversely, when actual capacity retention ratio Q is higher than capacity retention ratio Q on predicted curve Lpre in comparison at the same time, fee charging server 2 corrects predicted curve Lpre upward (in a direction in which the future decrease rate of capacity retention ratio Q decreases). Then, fee charging server 2 estimates a time when capacity retention ratio Q will decrease by a specified amount, based on corrected predicted curve Lpre. Thus, fee charging server 2 can estimate the remaining travel distance of vehicle 1, based on the time when capacity retention ratio Q will decrease by the specified amount (such as after how many days) and an actual value of a travel distance per day of vehicle 1. Fee charging server 2 transmits the estimated remaining travel distance to vehicle 1.

The processings in S702 to S707 are processing for providing vehicle 1 with advice about a recommended charging frequency of battery 15. In S702, fee charging server 2 calculates a ratio R1 of the actual value of the travel distance per day of vehicle 1 to the EV travel distance of vehicle 1.

The EV travel distance of vehicle 1 is a distance for which vehicle 1 can travel using power stored in battery 15 (if vehicle 1 includes an engine, without operating the engine). As the EV travel distance of vehicle 1, a specification value (catalog value) based on the capacity of battery 15 and the power efficiency of vehicle 1 may be used, or an actual value measured in vehicle 1 may be used. As the actual value of the travel distance per day of vehicle 1, for example, an average value of travel distances per day in the past can be used. Alternatively, a travel distance per day in the past under similar conditions, such as the day of the week and outside air temperature, may be used.

Fee charging server 2 compares calculated ratio R1 with two determination values that are less than 1 (in this example, ⅓ and ½). When ratio R1 is less than 1, the actual value of the travel distance per day of vehicle 1 is shorter than the EV travel distance of vehicle 1. Accordingly, traveling of vehicle 1 can be entirely performed by EV traveling. In addition, even after traveling is entirely performed by EV traveling, the power stored in battery 15 may have a margin.

Generally, when the battery is left for a long time with the SOC being higher than a reference value (for example, 80%), deterioration thereof is more likely to progress accordingly. Therefore, in order to suppress deterioration of battery 15, it is desirable not to increase the charging frequency of battery 15 excessively. This is because, by not performing charging of battery 15 intentionally when the power stored in battery 15 has a margin, it is possible to avoid battery 15 from having a high SOC.

When ratio R1 is less than ⅓ (YES in S703), fee charging server 2 advances the processing to S705. In S705, fee charging server 2 provides vehicle 1 with information that the recommended charging frequency is every three days or so, under typical use of vehicle 1 by the user.

Further, when ratio R1 is more than or equal to ⅓ and less than ½ (YES in S704), fee charging server 2 advances the processing to S706. In S706, fee charging server 2 provides vehicle 1 with information that the recommended charging frequency is every two days or so, under typical use of vehicle 1 by the user.

On the other hand, when ratio R1 is more than or equal to ½ (NO in S704), fee charging server 2 does not transmit a value serving as a measure of the recommended charging frequency to vehicle 1. By charging battery 15 every day when ratio R1 is relatively close to 1, such as when ratio R1 is more than or equal to ½, it is possible to prevent the power in battery 15 from being depleted during traveling of vehicle 1.

The processings in subsequent S708 to S713 are processing for providing vehicle 1 with advice about a recommended charging manner of battery 15.

Specifically, fee charging server 2 determines whether timer charging is preferable or normal charging is preferable (or how to combine these chargings) as a charging manner of battery 15 in vehicle 1, from the viewpoint of suppressing progress of deterioration of battery 15, and transmits the result of determination to vehicle 1.

It should be noted that timer charging is a charging manner that charges battery 15 according to a time schedule set for example by the user. Normal charging is a charging manner that starts charging of battery 15 without following a time schedule (so to speak, depending on the situation), for example when charging cable 4 is connected to vehicle 1 to allow battery 15 to be charged.

As described above, in order to suppress deterioration of battery 15, it is desirable to shorten the time for which battery 15 is left in a high SOC state as much as possible. Therefore, in S708, fee charging server 2 calculates a ratio R2 of the time for which battery 15 is left in a high SOC state to a total use time of battery 15. The length of the total use time of battery 15 can be obtained by measuring an elapsed time from manufacturing of battery 15 (which may be manufacturing of vehicle 1) to the present. The time for which battery 15 is left in a high SOC state can be calculated by calculating a cumulative value of the time for which battery 15 is left in a high SOC state to the present. Fee charging server 2 compares calculated ratio R2 with two determination values (in this example, 20% and 40%).

When ratio R2 is less than 20% (YES in S709), fee charging server 2 advances the processing to S711. In S711, fee charging server 2 provides vehicle 1 with information that it is desirable to continue the present charging manner, because progress of deterioration of battery 15 can be suppressed suitably (at a high level) by the charging manner of battery 15 in vehicle 1 employed up to the present (proper use of timer charging and normal charging).

Further, when ratio R2 is more than or equal to 20% and less than 40% (YES in S710), fee charging server 2 advances the processing to S712. Also in S712, fee charging server 2 provides vehicle 1 with information that it is desirable to continue the present charging manner in vehicle 1. This is because progress of deterioration of battery 15 can be suppressed to a certain degree (at an average level) by the charging manner of battery 15 employed up to the present.

On the other hand, when ratio R2 is more than or equal to 40% (NO in S710), the time for which battery 15 is left in a high SOC state is too long, and deterioration of battery 15 is more likely to progress. Therefore, fee charging server 2 advances the processing to S713, and provides vehicle 1 with information that it is desirable to further utilize timer charging. In the case of normal charging, a period from when charging of battery 15 is completed to when vehicle 1 starts traveling can become long. During this period, battery 15 is left in a high SOC state, and thus deterioration of battery 15 is more likely to progress. In contrast, when timer charging is utilized to set a time schedule such that charging of battery 15 is completed immediately before vehicle 1 starts traveling, the time for which battery 15 is left in a high SOC state becomes shorter, as compared with a case where timer charging is not utilized. Thus, progress of deterioration of battery 15 can be suppressed. When any of the processings in S711 to S713 ends, fee charging server 2 returns the processing to the flowchart shown in FIG. 16.

As described above, in the third embodiment, information about the remaining travel distance of vehicle 1 until lease of battery 15 ends (corresponding to the “first information” in accordance with the present disclosure) is provided, or information about the recommended charging frequency or the recommended charging manner for suppressing deterioration of battery 15 (corresponding to the “second information” in accordance with the present disclosure) is provided, from server 2 to the user. Although the description has been given of a case where three types of information are provided, only any one type or two types of information may be provided. In addition, at least one of the three types of information described above may be provided in the flowchart described in the second embodiment (see FIG. 13).

In the battery lease system in accordance with the third embodiment, when deterioration of battery 15 progresses by an amount corresponding to a lease fee paid beforehand by the user, the user is not allowed to use vehicle 1. However, it is difficult for the user to recognize the degree of progress of deterioration of battery 15. Thus, if the remaining travel distance for which the user can use vehicle 1 is unknown, the user may be dissatisfied. Accordingly, providing the user beforehand with the information about the remaining travel distance of vehicle 1 can prevent a so-called surprise situation for the user in which vehicle 1 suddenly becomes unable to travel. Thereby, user satisfaction can be improved.

In addition, by providing the user with the information about the recommended charging frequency or the recommended charging manner, the user can avoid setting the charging frequency of battery 15 to be unnecessarily high, or can utilize timer charging to charge battery 15. Thereby, progress of deterioration of battery 15 can be suppressed, which can increase the distance for which vehicle 1 can travel with the lease fee paid beforehand (remaining travel distance). As a result, user satisfaction can be improved.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A battery lending system that lends a battery to a user, comprising:
a vehicle configured to be equipped with the battery for traveling; and
a server that manages a lending fee to be paid by the user for lending of the battery, wherein
the vehicle permits traveling of the vehicle only for a period in which an index changes by a specified amount, when the user pays the lending fee, the index indicating a degree of progress of deterioration of the battery.

2. A vehicle comprising:
a battery for traveling of the vehicle;
a communication module that communicates with a server that manages a lending fee to be paid by a user for lending of the battery; and
a controller that permits traveling of the vehicle only for a period in which an index changes by a specified amount, when the user pays the lending fee, the index indicating a degree of progress of deterioration of the battery.

3. The vehicle according to claim 2, wherein the controller prohibits traveling of the vehicle, when the user does not pay the lending fee.

4. A server that manages a lending fee to be paid by a user for lending of a battery for traveling mounted on a vehicle, comprising:
a communication device that communicates with the vehicle; and
a processor that provides the vehicle with a notification for permitting traveling of the vehicle only for a period in which an index changes by a specified amount, when the user pays the lending fee, the index indicating a degree of progress of deterioration of the battery.

5. The server according to claim 4, wherein the processor manages the lending fee in association with the index, and determines the lending fee according to the index.

6. The server according to claim 5, wherein, as the index indicates that deterioration of the battery progresses more, the processor decreases the lending fee for the period in which the index changes by the specified amount.

7. The server according to claim 6, wherein, when the index exceeds a predetermined value as deterioration of the battery progresses, the processor increases the lending fee for the period in which the index changes by the specified amount, when compared with a case where the index is equal to the predetermined value.

8. The server according to claim 4, wherein the processor provides the user with first information about a distance for which the vehicle can travel until permission for traveling of the vehicle ends.

9. The server according to claim 4, wherein the processor provides the user with second information for increasing an electric vehicle (EV) travel distance for which the vehicle can travel using power stored in the battery, determined based on a status of use of the battery by the user.

10. The server according to claim 9, wherein the second information is information about a recommended charging frequency of the battery, determined based on a travel distance per day of the vehicle and the EV travel distance.

11. The server according to claim 9, wherein the second information is information about a recommended charging manner of the battery including timer charging performed according to a time schedule, determined based on a time for which the battery is left with an SOC of the battery being higher than a reference value.

12. A battery lending method for lending a battery for traveling mountable on a vehicle to a user, the method comprising:
determining a lending fee to be paid by the user for lending of the battery; and
permitting traveling of the vehicle only for a period in which an index changes by a specified amount, when the user pays the lending fee, the index indicating a degree of progress of deterioration of the battery.
